(19) United States
(12) Patent Application Publication
(10) Pub. No.: US 2025/0003030 A1
(43) Pub. Date: Jan. 2, 2025

(54) HIGH PURITY NI -CR-W-MO-LA ALLOY FOR POWDER BASED ADDITIVE MANUFACTURING

(71) Applicant: OERLIKON METCO (US) INC., Westbury, NY (US)

(72) Inventors: Dongmyoung LEE, Novi, MI (US); Satya N. KUDAPA, Sterling Heights, MI (US)

(73) Assignee: OERLIKON METCO (US) INC., Westbury, NY (US)

(21) Appl. No.: 18/705,809

(22) PCT Filed: Nov. 4, 2022
(86) PCT No.: PCT/US2022/048994

§ 371 Date: Apr. 29, 2024

Related U.S. Application Data
(60) Provisional application No. 63/276,187, filed on Nov. 5, 2021.

(51) Int. Cl. C22C 19/05; B22F 1/05; B22F 1/065; B22F 9/08; B22F 10/28; B33Y 10/00; B33Y 70/00

(52) U.S. Cl. CPC C22C 19/055; B22F 1/05; B22F 1/065; B22F 9/082; B22F 10/28; B33Y 10/00; B33Y 70/00; B22F 2009/0824; B22F 2301/15; B22F 2304/10; B22F 2998/10; B22F 2999/00

(57) ABSTRACT

A Ni—Cr—W—Mo—La alloy material powder for additive manufacturing has a composition of: 18.0-22.0 wt % Cr; 12.0-15.0 wt % W; 1.0-3.0 wt % Mo; 0.15-0.75 wt % Al; 0.005-0.05 wt % La; 0.001≤C≤0.045 wt %; and 0.005≤Si≤0.20 wt %; and remainder Ni and unavoidable residual elements and impurities. The powder has a general size distribution between 10 and 100 μm.

### CROSS-REFERENCE TO RELATED APPLICATION

This application claims the benefit under 35 U.S.C. § 119(e) of U.S. Provisional Application No. 63/276,187 filed Nov. 5, 2021, the disclosure of which is expressly incorporated by reference herein in its entirety.

### BACKGROUND

### 1. Field of the Invention

Embodiments relate to the technology of producing three-dimensional metal articles via powder-based additive manufacturing, such as selective laser melting (SLM), also known as laser-based powder bed fusion (L-PBF), direct energy deposition (DED)/laser metal deposition (LMD) or the electron beam melting (EBM) processes. Moreover, embodiments relate to a Ni—Cr—W—Mo—La alloy, in particular a Ni—Cr—W—Mo—La alloy powder, that is similar to a Haynes alloy 230, but has a modified chemical composition and controlled particle size for manufacturing crack-free or nearly crack-free components via SLM/L-PBF, DED/LMD and EBM processes.

### 2. Discussion of Background Information

Due to the unique processing of metal additive manufacturing, also known as 3D printing, with SLM/L-PBF (e.g., rapid solidification from melt), many legacy alloys are prone to cracking during 3D printing, since these alloys have been optimized for forging or casting processes and not the SLM/L-PBF processes.

According to manufacturer information (Brochure: Haynes 230 Alloy; A Ni—Cr—W—Mo alloy that combines excellent high-temperature strength and oxidation resistance with superior long term stability and good fabricability; Haynes International Inc 2007) on baseline wrought/cast commercial alloy, such as Haynes alloy 230, the alloy is readily weldable by a variety of techniques, including gas tungsten are (GTAW), gas metal are (GMAW), and resistance welding, which would place the basic alloy composition in the class of weldable materials. However, these welding techniques for which the Haynes 230 alloy is advantageous are distinct from welding process in the additive manufacturing processes discussed above.

Thus, despite being the Haynes 230 alloy being classified as readily weldable, the extremely rapid heating and cooling rates of the material during laser or electron beam welding results in formation of cracks in an article formed from the Haynes 230 alloy in a 3D printing process. This cracking is generally accepted to be mainly caused by internal stresses building up in the part during the laser or electron beam welding process. See Press Release: Flying High with VCSEL Heating; Fraunhofer ILT; Oct. 4, 2018.

The internal stresses building up in the part during 3D printing are caused by temperature gradients in the generated component, i.e., in the laser spot, temperatures above the melting point prevail, while outside of the laser spot, the component cools rapidly. Depending on the geometry and alloy, this temperature gradient can lead to cracks in the 3D printed material.

One traditional way of overcoming the cracking issue in Haynes 230 alloys or Haynes 230-like alloys comprises heating the powder bed to elevated temperatures during the 3D printing process either from the base plate of the build chamber of a powder additive manufacturing machine, such as an SLM/L-PBF machine, or, more effectively, from the top of the build chamber of the machine to directly heat the layer that is currently being welded, which can thereby avoid or reduce the internal stresses in the article that ultimately lead to the cracking. Using the latter, the temperature in the top layer can reach up to 900° C. and therefore high enough to avoid the cracking.

However, before a finished part can be removed from such a heated powder bed, it has to be cooled down to ambient temperature. Due to the low heat conductivity of powder beds, the heating up and cooling down of the powder bed requires a lot of time resulting in a significant decrease in productivity of the powder additive manufacturing process. Furthermore, expensive heating equipment and isolation as well as adaptation of the process chamber are needed.

Another way of overcoming the cracking issue in known Haynes 230 alloys or Haynes 230-like alloys is to apply a heat treatment at high external pressures and high temperatures to close and heal any remaining porosity and cracks in the 3D printed material. This is known as Hot Isostatic Pressing (HIP). This process works for closed internal pores and cracks but cannot heal any surface cracking. It also adds an additional processing step to the 3D printing of articles, which adds to manufacturing costs.

Hence, it would be beneficial to provide an alloy similar to the Haynes 230 alloy composition that can be processed in non- or only slightly heated powder beds and has no need for post 3D printing processing steps to heal cracks via HIP.

### SUMMARY

The embodiments described herein overcome the above-identified deficiencies in the known art by providing an alloy with optimized chemistry in order to control of the particle size distribution of the alloy when provided as powder for the SLM/L-PBF process of 3D printing.

In embodiments, a modified Nickel-base alloy with a high content of Cr and W for additive manufacturing of three-dimensional articles with a reduced cracking tendency is disclosed, as well as suitable process parameters for manufacturing such an article. The composition of the powder according to the present invention is based on a modified composition of the known commercially available prior art Haynes 230 alloy composition having a specification of (in wt. −%): 20.0-24.0 Cr, 13.0-15.0 W, 1.0-3.0 Mo, 0.3-1.0 Mn, 0.25-0.75 Si, 0.20-0.50 Al, 0.05-0.15 C, 0.005-0.05 La, max. 3 Fe, max. 5 Co, max 0.1 Ti, max 0.015 B, remainder Ni and unavoidable residual elements and impurities. Moreover, while this known composition is available as a cast or wrought material, the embodiments of the modified composition are preferably directed to material in the form of a powder, e.g., a mainly spherical powder.

It has been found that the generally accepted known limits of maximum 0.75 wt % Si, maximum 1.0 wt % Mn and, in particular, maximum 0.15 wt % C, as well as the generally accepted known typical alloying contents of nominally 0.4 wt % Si, nominally 0.5 wt % Mn and, in particular, nominally 0.1 wt % C in the known Hayes 230 alloy are all too high for a powder to be used in powder-based additive manufacturing, like SLM/L-PBF, if crack-free or nearly crack-free three-dimensional articles of complex shapes are to be provided on a reliable basis. Moreover, it has been found that, as discussed herein and in accordance with embodiments, by a tight control and modification of specific elements, such as modifying the C and Si content of the known Hayes 230 alloy composition to be 0.001≤C≤0.045 wt %; and 0.005≤Si≤0.20 wt %, and controlling particle size of the powder material to be 28≤D50≤38 μm, crack-free articles can be produced in powder-based additive manufacturing processes, such as in SLM/L-PBF, DED/LMD or EBM machines, over a very broad range of processing parameters without preheating and without HIP.

In a preferred embodiment of the present invention, the alloy has a content of 0.01-0.04 wt % C and approximately 0.01-0.10 wt % Si and a D50 as determined in accordance with ASTM B822 of 28-38 μm.

The powder-based additive manufacturing processing parameters are selected in a way that the laser volume energy density of the process, E_{D}, according to this invention is selected in the range of 35 to 150 J/mm³, in preferred embodiments is in the range 60 to 110 J/mm³, even more preferred to be in the range 65 to 100 J/mm³.

The laser volume energy density is calculated as

$${E}_{D} = P / v \cdot h \cdot t ,$$

where P is the laser power in W, v is the laser surface scanning speed (in mm/s), h is the hatch spacing (in mm) and t is the layer thickness (in mm) of each of the welded powder layers the powder-based additive manufacturing process.

In other embodiments, the layer thickness of each welded powder layer may be in the range of 0.01-0.1 mm, preferably 0.02-0.07 mm and even more preferably in the range 0.03-0.05 mm.

Embodiments are directed to a Ni—Cr—W—Mo—La alloy material powder for additive manufacturing that includes a composition of: 18.0-22.0 wt % Cr; 12.0-15.0 wt % W; 1.0-3.0 wt % Mo; 0.15-0.75 wt % Al; 0.005-0.05 wt % La; 0.001≤C≤0.045 wt %; 0.005≤Si≤0.20 wt %, and remainder Ni and unavoidable residual elements and impurities. The powder has a general size distribution between 10 and 100 μm.

According to embodiments, the powder can include spherical grains.

In accordance with embodiments, the composition may further include: Fe greater than 0 wt % and <5 wt %; Co greater than 0 wt % and <7 wt %; Ti greater than 0 wt % and <0.5 wt %; B greater than 0 wt % and <0.020 wt %; Mn greater than 0 wt % and ≤0.25 wt %.

In still other embodiments, the Mn content can be greater than 0 wt % and less than 0.10 wt %.

In other embodiments, the Si content may be 0.005≤Si≤0.10 wt %.

According to other embodiments, the powder may be a generally spherical powder having a size distribution between 10 to 50 μm and a D50 of 28 to 38 μm.

In embodiments, an additive manufacturing process for producing three-dimensional articles with the above-described embodiments of the alloy material powder includes combining laser parameters of laser power, laser surface scan velocity, hatch distance and build layer thickness to produce a laser volume energy density for 3D printing the material in a range of 30 to 150 J/mm³, preferably, in the range of 60 to 110 J/mm³, and most preferably in the range of 65 to 100 J/mm³. Further, layers are applied with a thickness of each layer ranging from 0.01 to 0.1 mm, and the additive manufacturing process includes a selective laser melting process, a laser-based powder bed fusion process, a direct energy deposition process, a laser metal deposition process or an electron beam melting process.

Embodiments are directed to an alloy material powder for additive manufacturing processing that includes 0.001≤C≤0.045 wt %; and 0.005≤Si≤0.20 wt %. The powder has a general size distribution between 10 and 100 μm.

Embodiments are directed to a method for 3-dimensional printing an article having a crack-free structure. The method includes supplying successive layers of a powder having a general size distribution between 10 and 100 μm to the powder additive manufacturing process having a composition that includes 0.001≤C≤0.045 wt %; and 0.005≤Si≤0.20 wt %; and applying a volume energy density of 38.7 J/mm3 to 152.29 J/mm3 to the successive layers of the powder.

According to embodiments, the powder composition may further includes 18.0-22.0 wt % Cr; 12.0-15.0 wt % W; 1.0-3.0 wt % Mo; 0.15-0.75 wt % Al; 0.005-0.05 wt % La; greater than 0 wt % and max. 5 wt % Fe; greater than 0 wt % and max. 7 wt % Co; greater than 0 wt % and max 0.5 wt % Ti; greater than 0 wt % and max 0.020 wt % B; and greater than 0 wt % and less than 0.25 wt % Mn, with a remainder Ni and unavoidable residual elements and impurities. Moreover, the additive manufacturing process can include one of selective laser melting (SLM), laser-based powder bed fusion (L-PBF), direct energy deposition (DED)/laser metal deposition (LMD) or the electron beam melting (EBM) processes. The volume energy density (ED) can be determined from the equation: ED=P/v·h·t, where P is a laser power in W, v is a laser surface scanning speed, h is a hatch spacing and t is a layer thickness of each of the welded powder layers the powder-based additive manufacturing process. comprises combining laser parameters of laser power, laser surface scan velocity, hatch distance and build layer thickness. The powder may be a generally spherical powder having a size distribution between 10 to 50 μm and a D50 of 28 to 38 μm.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIGS. 1A and 1B show severe cracking on cross-sectional surfaces of an article produced in a powder-based additive manufacturing process, such as a standard SLM/L-PBF system, from an Ni—Cr—W—Mo—La alloy in spherical powder form with chemistry according to the prior art, where FIG. 1A is an optical microscopy image showing a cross section parallel to the build plate of the machine and FIG. 1B is an optical microscopy image showing a cross section normal to the machine build plate; and.

FIGS. 2A-2C show crack-free cross-sectional surfaces of an article produced in a powder-based additive manufacturing process, such as a standard SLM/L-PBF system, from an Ni—Cr—W—Mo—La alloy in spherical powder form with chemistry according to embodiments, where FIG. 2A is an optical microscopy image showing a cross section normal to the machine build plate and parallel to the build direction in an etched condition, FIG. 2B is a scanning electron microscope (SEM) image of a cross-section normal to the machine build plate, and FIG. 2C is an SEM image of a cross-section parallel to the build direction.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Table 1 shows comparative examples of chemical compositions of various known Ni—Cr—W—Mo—La alloys, generally referred to as Haynes 230 alloys, which are commercially available in wrought or cast form. In particular, Table 1 shows compositions of known Haynes 230 alloys (Ni—Cr—W—Mo) from Haynes International (See Brochure: Haynes 230 Alloy; A Ni—Cr—W—Mo alloy that combines excellent high-temperature strength and oxidation resistance with superior long term stability and good fabricability; Haynes International Inc 2007), Ulrich Metals (See www.ulbrich.com/alloys/haynes-230-uns-n06230) and NeoNickel (See www.neonickel.com).

TABLE 1

| | Haynes International | | | Ulbrich Metals | | | NeoNickel | | |
|---|---|---|---|---|---|---|---|---|---|
| | Material Form | | | | | | | | |
| | cast/forged | | | wrought/rolled | | | various wrought forms | | |
| Element | nominal | min | max | nominal | min | max | nominal | min | max |

| | | | | | | |
|---|---|---|---|---|---|---|
| Ni | 57 | | 47.00 | 65.00 | 47 | 67 |
| Cr | 22 | | 20.00 | 24.00 | 20 | 24 |
| W | 14 | | 13.00 | 15.00 | 13 | 15 |
| Mo | 2 | | 1.00 | 3.00 | 1 | 3 |
| Fe | | 3 | | 3.00 | | 3 |
| Co | | 5 | | 5.00 | | 5 |
| Mn | 0.5 | | 0.30 | 1.00 | 0.3 | 1 |
| Si | 0.4 | | 0.25 | 0.75 | 0.25 | 0.75 |
| Nb | | 0.5 | | | | |
| Ta | | | | | | |
| Al | 0.3 | | 0.20 | 0.50 | 0.20 | 0.50 |
| Ti | | 0.1 | | 0.10 | | 0.10 |
| Cu | | | | 0.50 | | 0.50 |
| C | 0.1 | | 0.05 | 0.15 | 0.05 | 0.15 |
| La | 0.02 | | 0.005 | 0.05 | 0.005 | 0.05 |
| B | | 0.015 | | 0.015 | | 0.015 |
| P | | | | 0.030 | | 0.03 |
| S | | | | 0.015 | | 0.015 |
| Others | | | | | | |

Table 2 shows comparative examples of known Ni—Cr—W—Mo—La alloys supplied in the form of powder with a grain size of approx. 10 to 100 m for powder bed additive manufacturing in the SLM/L-PBF process. In particular, Table 2 shows the compositions of alloy powders similar to Haynes 230 alloy, such as AMPERPRINT 0211 from Hoganas (www.hoganas.com), TRUFORM 230 from Praxair Surface Technologies (www.praxairsurfacetechnology.com) and METCOADD H23X-A from Oerlikon Metco AG.

TABLE 2

| | Hoganas | | | Praxair Surface Techn. | | | Oerlikon Metco | | |
|---|---|---|---|---|---|---|---|---|---|
| | (Amperprint 0211) | | | (Truform 230) | | | Standard (MetcoAdd H23X-A) | | |
| | Material Form | | | | | | | | |
| | powder for additive | | | powder for additive | | | powder for additive | | |
| | manufacturing | | | manufactuirng | | | manufacturing | | |
| Element | nominal | min | max | nominal | min | max | nominal | min | max |

| | | | | | |
|---|---|---|---|---|---|
| Ni | Bal | | Bal | Bal | |
| Cr | 20.0 | 24.0 | 22 | 20 | 24 |
| W | 13.0 | 15.0 | 14 | 13 | 15 |
| Mo | 1.0 | 3.0 | 2 | 1 | 3 |
| Fe | | 3.00 | | | 3 |
| Co | | 3.00 | | | 5 |
| Mn | 0.30 | 1.00 | 0.5 | 0.3 | 1.0 |
| Si | 0.25 | 0.75 | 0.4 | 0.25 | 0.75 |
| Nb | | | | | |
| Ta | | 0.20 | | | |
| Al | 0.20 | 0.50 | 0.30 | 0.20 | 0.50 |
| Ti | | 0.10 | | | 0.1 |
| Cu | | 0.20 | | | 0.5 |
| C | 0.05 | 0.15 | 0.10 | 0.05 | 0.15 |
| La | | | 0.002 | 0.005 | 0.05 |
| B | | 0.015 | | | 0.015 |
| P | | 0.030 | | | 0.030 |
| S | | 0.010 | | | 0.015 |
| Others | | | | | 0.1 |

A fair review of Tables 1 and 2 reveals that the listed known Ni—Cr—W—Mo—La alloys compositions all specify 0.05≤C≤0.15 wt %, 0.25≤Si≤0.75 wt % and 0.30≤Mn≤1.00 wt % or describe a typical, middle-of-the-specification (nominal) compositions of C=0.1 wt % nominal, Si=0.4 wt % nominal and Mn=0.5 wt % nominal, irrespective of whether the composition is supplied in a powder form for the SLM/L-PBF process or in cast or wrought form.

Embodiments are also directed to a Nickel-based alloy with a high content of Cr and W. However, in contrast to the known Ni—Cr—W—Mo—La compositions described in Tables 1 and 2, the Ni—Cr—W—Mo—La composition according to embodiments is modified so that when used in powder-based additive manufacturing of three-dimensional articles, a reduced cracking tendency of the article results, Thus, while the modified composition of the Ni—Cr—W—Mo—La powder according to the embodiments has a specification of (in wt. -%): 20.0-24.0 Cr, 13.0-15.0 W, 1.0-3.0 Mo, 0.20-0.50 Al, 0.005-0.05 La, max. 3 Fe, max. 5 Co, max 0.1 Ti, max 0.015 B, like the known compositions, the modified composition of the embodiments also includes a tight control and modification of additional elements, such as 0.001≤C≤0.045 wt %; 0.005≤Si≤0.20 wt %; and Mn at ≤0.25 wt %, where the remainder Ni and unavoidable residual elements and impurities. Further, the modified composition of the embodiments further includes control of particle size of the powder material to be 28≤D50≤38 μm.

The modified composition of the embodiments has shown superior results to the known compositions in that crack-free articles can be produced by a powder-based additive manufacturing process over a very broad range of processing parameters without preheating and without HIP.

### Example 1

A metal alloy according to the prior art compositions shown in Tables 1 and 2 and having an actual composition of Cr=20.5 wt %, W=13.6 wt %, Mo=2.0 wt %, Mn=0.35 wt %, Si=0.42 wt %, Al=0.3 wt %, C=0.09 wt %, La=0.02 wt %, Fe=1.0 wt %, Co=0.3 wt %, Ti=0.06 wt %, B=0.006 wt %, remainder Ni and unavoidable residual elements and impurities was produced by melting and gas atomization to provide a largely spherical powder having grains generally sized from about 10 to 50 μm and a D50 of 37 μm. This known metal alloy powder was used in an SLM/L-PBF powder bed additive manufacturing to provide 3D printed articles using an EOS M280 machine supplied by EOS GmbH—Electro Optical Systems. A volume energy density of 72.5 J/mm³ was applied to process the material for 3D printing with a build layer thickness of 0.040 mm.

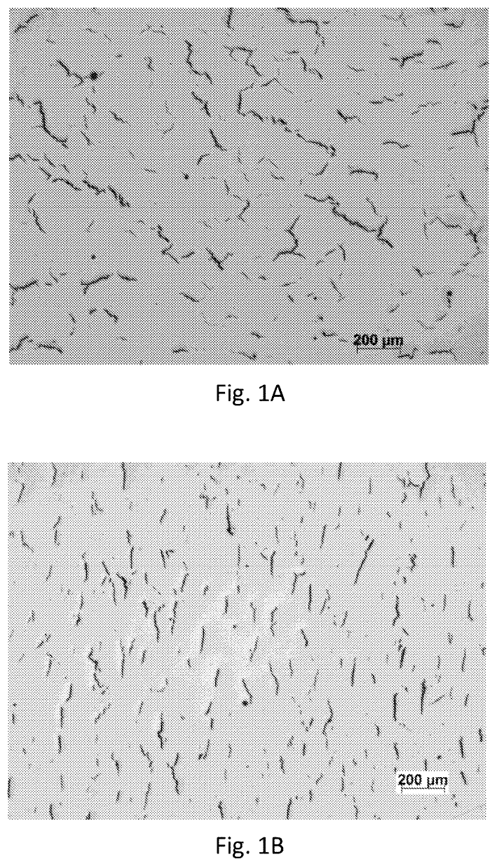

As can be seen in FIGS. 1A and 1B, which are optical microscopy images showing severe cracking can be observed in the article, the as-manufactured structure of this 3D printed material contains a high number of cracks as seen in cross sections parallel to the base plate of theM280 machine (FIG. 1A) and in cross-sections normal to the base plate of the M280 machine (FIG. 1B). The alloy described above was also printed using various processing parameters with volume energy density (E_{D}) adjusted within a range from 55 to 75 J/mm³ but no crack-free structure(s) could be obtained for this known composition in the entire field of parameters investigated.

While the alloy composition for the known Ni—Cr—W—Mo—La alloy similar to Haynes 230 alloy used in this example is derived from the cast or wrought compositions of a Haynes 230 alloy classed as readily weldable by conventional welding techniques, it was found that, if crack-free or nearly crack-free structures for 3D printed articles are required, the cast or wrought composition of the Haynes 230 alloy is not suitable for producing 3D printed articles by SLM/L-PBF processing.

To overcome these shortcomings identified in the structures formed from the prior art Haynes 230 alloy compositions, embodiments are directed to a modification of the known alloy in which a stricter control of certain constituent elements in the known alloy composition is provided in order to achieve crack-free structures of 3D printed articles from such modified alloys. It could be demonstrated that, in particular, the content of C, Si and Mn in the known compositions are too high for powder to be used in SLM/L-PBF for a crack-free surface structure.

### Example 2

A metal alloy according to the embodiments has an actual chemical composition of Cr=19.9 wt %, W=13.4 wt %, Mo=2.0 wt %, Mn=0.01 wt %, Si=0.02 wt %, Al=0.18 wt %, C=0.01 wt %, La<0.005 wt %, Fe=0.1 wt %, Co=0.02 wt %, remainder Ni and unavoidable residual elements and impurities was produced by melting and gas atomization to provide a largely spherical powder having grains generally sized from about 10 to 50 μm and a D50 of 30 μm. This metal alloy was processed in SLM/L-PBF powder bed additive manufacturing using an EOS M290 machine supplied by EOS GmbH—Electro Optical Systems using selected processing parameters of volume energy density E_{D} to perform a total of 35 3D printing processes, in which the volume energy density utilized was between 38.7 J/mm³ and 152.29 J/mm³.

The 3D printed material or article was investigated in the as-printed state for defects, which are commonly associated with the SLM/L-PBF process, e.g., porosity and cracks. While different levels of porosity were observed for the 35 3D printing tests, no cracks were observed. Table 3 below shows selected results, such as number of cracks, porosity and maximum pore size (in μm) for various parameter field investigated with the Ni—Cr—W—Mo—La alloy having a composition according to embodiments.

TABLE 3

| | Energy | | | Maximum |
|---|---|---|---|---|
| Test | Density | No of | Porosity | pore size |
| No. | [J/mm3] | cracks | [%] | [μm] |
| 35 | 38.7 | 0 | 1.482 | 21.37 |
| 19 | 69.7 | 0 | 0.118 | 19.19 |
| 24 | 100.43 | 0 | 0.081 | 18.52 |
| 29 | 152.29 | 0 | 0.138 | 21.27 |

### Example 3

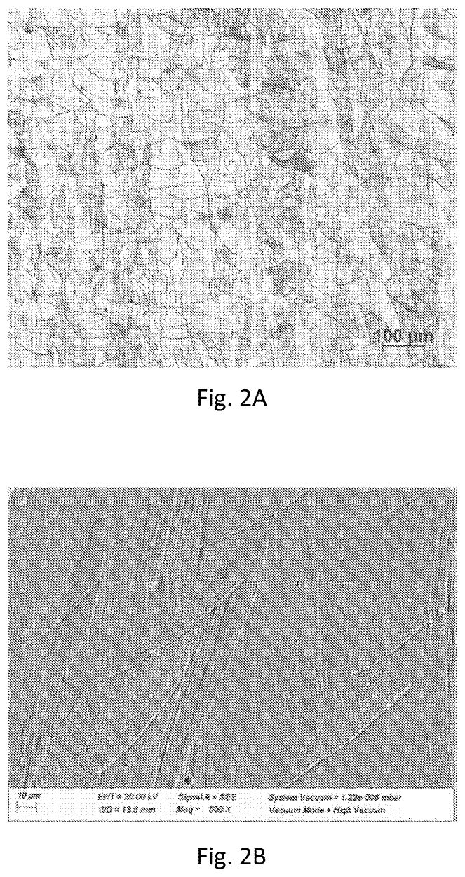

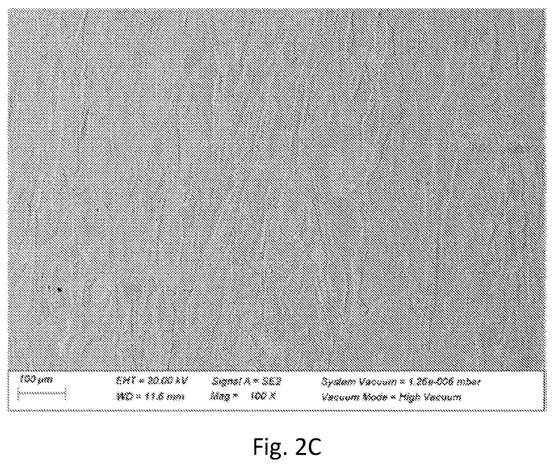

The alloy composition as described in Example 2, i.e., a Ni—Cr—W—Mo—La alloy in spherical powder form with chemistry according to embodiments was used in SLM/L-PBF powder bed additive manufacturing to produce 3D printed articles using an EOS M290 machine supplied by EOS GmbH-Electro Optical Systems. A volume energy density of 71.5 J/mm³ was applied to process the material with a build layer thickness of 0.040 mm. The resulting microstructure of this 3D printed material is shown in FIGS. 2A-2C, in which no cracking is observed.

FIG. 2A shows an optical microscopy image of a cross section of the 3D printed material in a plane normal to the build plate and parallel to the build direction in an etched condition. The individual laser weld tracks can be seen in this image. FIGS. 2B and 2C show scanning electron microscope (SEM) images of a cross section normal to the machine build plate and parallel to the build direction, respectively. As can be seen from FIGS. 2A-2C, the resulting structure is dense and free of cracks.

Compared to the structures produced in Example 2, the selected parameter to achieve this exemplary structure can be regarded an optimized one as the structure is not only crack-free, but the structure of the printed material according to this Example exhibits a low value of porosity in the as-manufactured state of 0.024% porosity, which corresponds to 99.97% density of the structure, and a maximum pore size of only 17.86 μm. Thus, the material composition and processing parameters of Example 3 represent a preferred embodiment of the present invention.

### Example 4

A metal alloy according to the embodiments having an actual chemical composition of Cr=20.0 wt %, W=13.6 wt %, Mo=1.9 wt %, Mn=0.0002 wt %, Si=0.085 wt %, Al=0.21 wt %, C=0.0046 wt %, La=0.023 wt %, Fe=0.035 wt %, Co=0.129 wt %, remainder Ni and unavoidable residual elements and impurities was produced by melting under vacuum and gas atomization to provide a largely spherical powder having grains generally sized from about 10 to 50 μm and a D50 of 31 μm. This metal alloy was processed in standard SLM/L-PBF powder bed additive manufacturing using an EOS M290 machine supplied by EOS GmbH—Electro Optical Systems with processing parameters selected to perform six test 3D prints with the volume energy density E_{D} adjusted between 60.0 J/mm³ to 75.0 J/mm³. The six test 3D prints were produced for part density and tensile property samples.

The produced 3D printed material/article was investigated in the as-printed state for defects as commonly associated with the SLM/L-PBF process such as porosity and cracks. The material was further tested for tensile properties at room temperature and at 900° C. (according to ASTM E8M-21 after a heat treatment at 1177° C. for 1 hour followed by rapid cooling in nitrogen). Cracks and porosity in the printed material/article were investigated using high-resolution image analysis. The results showed no cracks and almost no porosity as confirmed by the high levels of material density that was better than 99.99% in all 5 test prints with E_{D} ranging from 66.7 to 75.0. For the production of the hardware for the tensile tests an E_{D} of 60.0 was selected for the 3D printing.

Table 4 shows the results of tensile tests at room temperature (25° C.) and elevated temperature (900° C.) according to ASTM E8M for products/articles produced using a standard SLM/L-PBF system (EOS M290 machine, supplied by EOS GmbH—Electro Optical Systems), from a powder of Ni—Cr—W—Mo—La alloy with chemistry according to embodiments with a D50 of 31 μm and applying a volume energy density of 60.0 J/mm³. From the results of the tensile tests in Table 4 below, it can be seen that very high levels of ductility for the tests, which is expressed by elongation at rupture values, is achieved for the tests, which is a typical sign of a very successful 3D print run for the material. Further, there seems to be little difference for the results obtained for two different test directions, i.e., Z and XY, which are normal or parallel to the build layers and which is an additional advantage of the material according to embodiments.

TABLE 4

| | | | Ultimate | |
|---|---|---|---|---|
| | Test | Yield | Tensile | Elongation |
| Test | Temperature | Strength | Strength | at Rupture |
| Direction | [° C.] | [N/mm²] | [N/mm²] | [ % ] |
| Z | 25 | 352 | 792 | 58 |
| XY | 25 | 364 | 823 | 54 |
| Z | 900 | 174 | 214 | 21 |
| XY | 900 | 166 | 214 | 27 |

### Test Directions Relative to the Build Layers:

Z test direction is 90° to the build plate and build layers
XY test direction is parallel to the build plate and build layers

Thus, cracking in materials/articles produced from Ni—Cr—W—Mo—La alloys in additive material manufacturing processes can be limited by controlling the C, Si and Mn content of the alloys to be within the disclosed ranges of 0.001≤C≤0.045 wt %; 0.005≤Si≤0.20 wt %; and Mn at ≤0.25 wt %, which has been shown to be suitable to produce a crack-free 3D printed article.

Of course, the embodiments are not limited to the expressly described examples. In this regard, it is expected that the disclosed Ni—Cr—W—Mo—La alloy is not only suitable for the SLM/L-PBF process but also for other known powder-nozzle additive manufacturing processes, such as laser metal deposition (LMD) or direct energy deposition (DED), as well as an electron beam melting (EBM) process without departing from the advantages described herein.

5941 It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A Ni—Cr—W—Mo—La alloy material powder for additive manufacturing, comprising:
a composition of:
18.0-22.0 wt % Cr;
12.0-15.0 wt % W;
1.0-3.0 wt % Mo;
0.15-0.75 wt % Al;
0.005-0.05 wt % La;
0.001≤C≤0.045 wt %;
0.005≤Si≤0.20 wt %, and
remainder Ni and unavoidable residual elements and impurities,
wherein the powder has a general size distribution between 10 and 100 μm.

2. The Ni—Cr—W—Mo—La alloy material powder according to claim 1, wherein the powder comprises spherical grains.

3. The Ni—Cr—W—Mo—La alloy material powder according to claim 1, the composition further comprising:
Fe greater than 0 wt % and <5 wt %;
Co greater than 0 wt % and <7 wt %;
Ti greater than 0 wt % and <0.5 wt %;
B greater than 0 wt % and <0.020 wt %;
Mn greater than 0 wt % and ≤0.25 wt %.

4. The Ni—Cr—W—Mo—La alloy material powder according to claim 1 wherein the Mn content is greater than 0 wt % and less than 0.10 wt %.

5. The Ni—Cr—W—Mo—La alloy material powder according to claim 1 wherein the Si content is 0.005≤Si≤0.10 wt %.

6. The Ni—Cr—W—Mo—La alloy material powder according to claim 1, wherein the powder is a generally spherical powder having a size distribution between 10 to 50 μm and a D50 of 28 to 38 μm.

7. An additive manufacturing process for producing three-dimensional articles with the alloy material according to claim 1, the process comprising:
combining laser parameters of laser power, laser surface scan velocity, hatch distance and build layer thickness to produce a laser volume energy density for 3D printing the material in the range of 30 to 150 J/mm³.

8. The additive manufacturing process for additive manufacturing of three-dimensional articles according to claim 7, wherein the laser volume energy density is in the range of 60 to 110 J/mm³.

9. The additive manufacturing process for additive manufacturing of three-dimensional articles according to claim 7, wherein the laser volume energy density is in the range of 65 to 100 J/mm³.

10. The additive manufacturing process for additive manufacturing of three-dimensional articles according to claim 7, wherein layers are applied with a thickness of each layer ranging from 0.01 to 0.1 mm.

11. The additive manufacturing process for additive manufacturing of three-dimensional articles according to claim 7, the additive manufacturing process comprising a selective laser melting process.

12. The additive manufacturing process for additive manufacturing of three-dimensional articles according to claim 7, the additive manufacturing process comprising a laser-based powder bed fusion process.

13. The additive manufacturing process for additive manufacturing of three-dimensional articles according to claim 7, the additive manufacturing process comprising a direct energy deposition process.

14. The additive manufacturing process for additive manufacturing of three-dimensional articles according to claim 7, the additive manufacturing process comprising a laser metal deposition process.

15. The additive manufacturing process for additive manufacturing of three-dimensional articles according to claim 7, the additive manufacturing process comprising an electron beam melting process.

16. An alloy material powder for additive manufacturing processing, comprising:
0.001≤C≤0.045 wt %;
0.005≤Si≤0.20 wt %; and
wherein the powder has a general size distribution between 10 and 100 μm.

17. A method for 3-dimensional printing an article having a crack-free structure, the method comprising:
supplying successive layers of a powder having a general size distribution between 10 and 100 μm to the powder additive manufacturing process having a composition that includes 0.001≤C≤0.045 wt %; and 0.005≤Si≤0.20 wt %; and
applying a volume energy density of 38.7 J/mm³ to 152.29 J/mm³ to the successive layers of the powder.

18. The method according to claim 17, wherein the powder composition further includes 18.0-22.0 wt % Cr; 12.0-15.0 wt % W; 1.0-3.0 wt % Mo; 0.15-0.75 wt % Al; 0.005-0.05 wt % La; greater than 0 wt % and max. 5 wt % Fe; greater than 0 wt % and max. 7 wt % Co; greater than 0 wt % and max 0.5 wt % Ti; greater than 0 wt % and max 0.020 wt % B; and greater than 0 wt % and less than 0.25 wt % Mn, with a remainder Ni and unavoidable residual elements and impurities.

19. The method according to claim 17, wherein the additive manufacturing process comprises one of selective laser melting (SLM), laser-based powder bed fusion (L-PBF), direct energy deposition (DED)/laser metal deposition (LMD) or the electron beam melting (EBM) processes.

20. The method according to claim 17, wherein the volume energy density (E_{D}) is determined from the equation:
$${E}_{D} = P / v \cdot h \cdot t ,$$
where P is a laser power in W, v is a laser surface scanning speed, h is a hatch spacing and t is a layer thickness of each of the welded powder layers the powder-based additive manufacturing process. comprises combining laser parameters of laser power, laser surface scan velocity, hatch distance and build layer thickness.

21. The method according to claim 17, wherein the powder is a generally spherical powder having a size distribution between 10 to 50 μm and a D50 of 28 to 38 μm.
